(19) United States
(12) Patent Application Publication
(10) Pub. No.: US 2006/0125199 A1
(43) Pub. Date: Jun. 15, 2006

(54) Skateboard deck with grooves on it for grip, and metal plates under the front and rear end for protection

(76) Inventor: Lui Rasto Kodames, Santa Monica, CA (US)

Correspondence Address: Lui Rasto Kodames, 2623 Santa Monica Blvd., Santa Monica, CA, 90404, US

(21) Appl. No.: 10/751,136

(22) Filed: Jan. 5, 2004

(51) Int. Cl. B62M 1/00

(52) U.S. Cl. 280/87.042

(57) ABSTRACT

I have created grooves on a skateboard deck for design and grip. The groove/ or grooves will be exclusive or created from a template. The metal plates under the skateboard decks front and rear end will protect the actual deck from serious damage. A hand/ or machine router, or type 4 lasers will create the grooves depending on the method I will prefer for the design. The section where the metal plates will be placed are going to be routed for a perfect fit in exception for the tip facing the end that will protrude 0.25 allowing protection from collision.

### BACKGOUND OF THE INVENTION

1. Field of Invention

This invention specifically relates to the grip needed to ride a skateboard, and protection from damage towards the nose and tail of the skateboard The idea is based on a unique and exclusive design and ideal method for grip. In most cases the top of the skateboard usually has grip tape on it. This grip tape is like sandpaper with adhesive on the back that sticks to the deck of the skateboard This allows the sole of the shoe or foot not to slip off while riding. The metal plates I have placed under the front and rear end of the deck are to prevent serious damage when colliding into something. Example: the skateboard can escape the control of the user and result in the front end colliding with something capable of damaging it. The metal plate placed under the front end will protect the deck from damage. The metal plate placed under the tail is for when standing the skateboard deck on its own tail, thus not allowing damage to the tail.

2. Description of the Prior Art

There is no Description of the Prior Art.

### SUMMARY OF THE INVENTION

The primary objects of the present invention are to provide a unique grip design with protection for the front and rear end of the skateboard in a collision.

### BRIEF DESCRIPTION OF THE DRAWINGS

FIG. 1 is the top view of the skateboard with grooves for grip, and metal plates under the front and rear end for protection.

FIG. 2 is a side perspective view of part of the skateboard with grooves for grip, and metal plates under the front and rear end for protection.

FIG. 3 is the bottom view of part of the skateboard with grooves for grip, and metal plates under the front and rear end for protection.

FIG. 4 is the top view of part of the skateboard with grooves for grip, and metal plates under the front and rear end for protection.

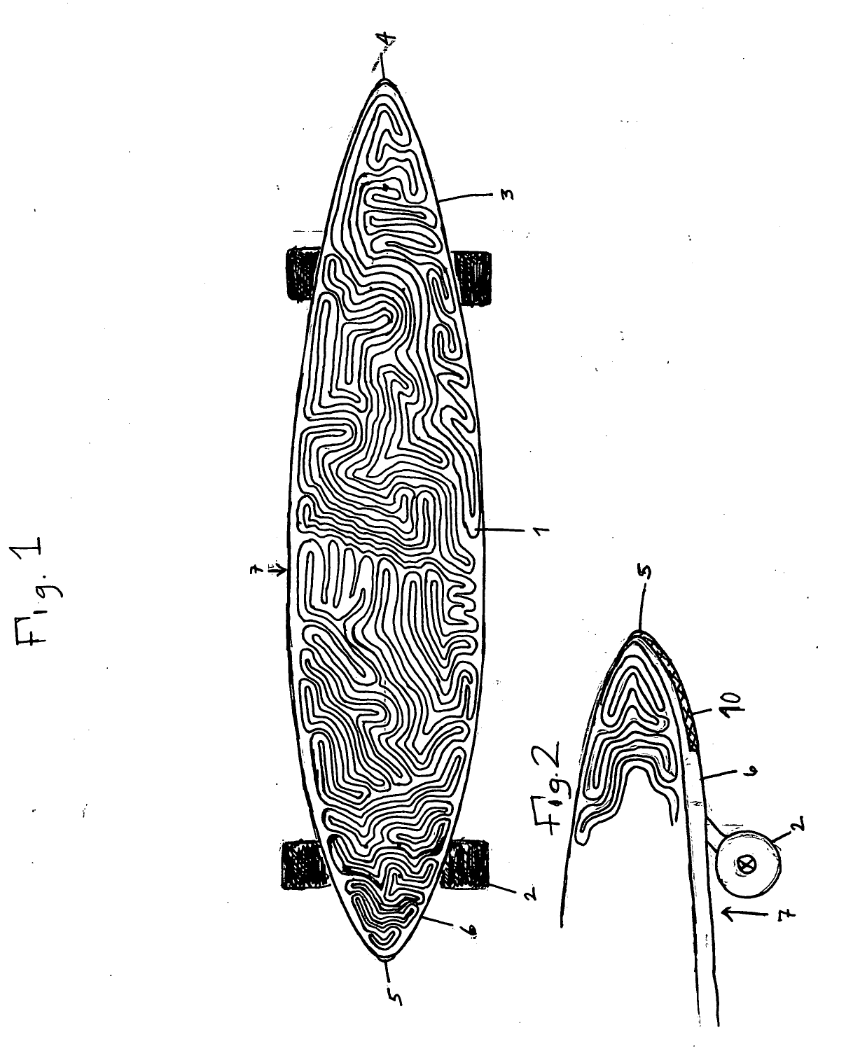

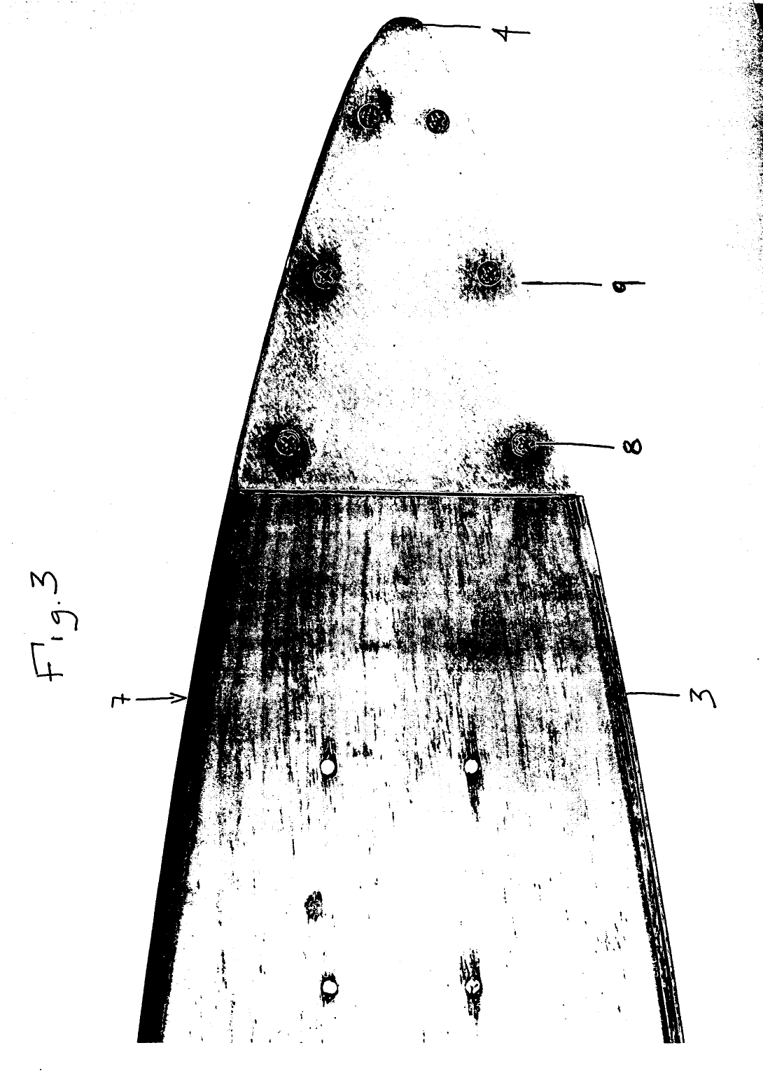

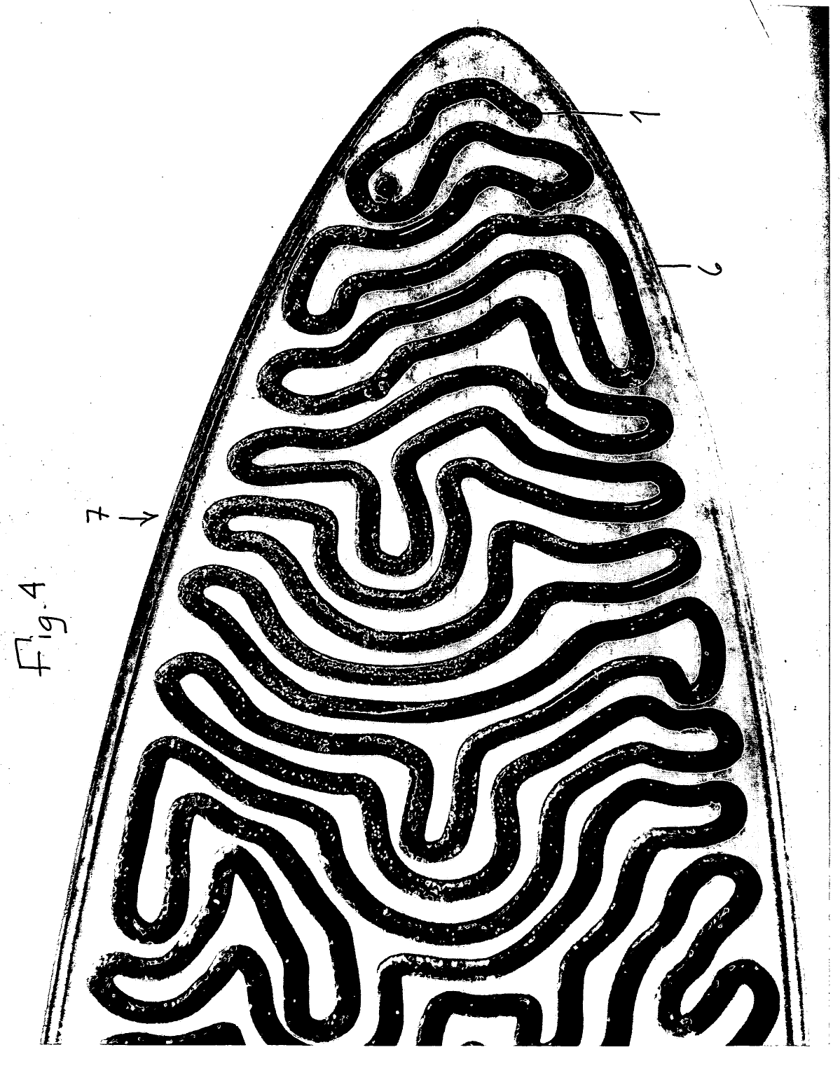

### LIST OF REFERENCE NUMERALS UTILIZED IN THE DRAWING

1—Groove on skateboard deck
2—skateboard wheel
3—rear end of skateboard deck
4—tip of metal plate under the tear end-of the skateboard deck
5—tip of metal plate under the front end of the skateboard deck
6—front end of skateboard deck
7—skateboard with grooves for grip, and metal plates under the front and rear end for protection
8—one of the screws holding the metal plate under the rear end of the skateboard deck
9—metal plate under rear end
10—metal plate under front end

### DETAILED DESCRIPTION OF THE INVENTION

The skateboards deck is shaped either off my own template or an exclusive design. Once the board has been shaped it will be cut from the desired material (wood, metal, plastic, acrylic, fiberglass). The machine in the cutting process for the shapes of the decks will be by a router/band saw/or a type 4 laser. Once shaped, cut, and sanded the material will be drilled into for the trucks (mounting axel) that holds the wheels. The next stage is using a hand router/or automated router/or type 4 laser to create the grooves. The grooving process varies only due to exclusive and or template decks. In the future templates for the boards will allow production in mass with machine routers and/or lasers. Starting from the nose of the skateboard down to the tail the groove will be either a constant line forming designs and/or separate lines forming designs. The depth of the groove will be ⅛^{th} of an inch, but can vary depending on the materials thickness and strength The metal plates that will be used for protection will be placed under the nose and tail of the skateboard The nose and tail are the front and rear end of the skateboard. The metal plate will vary in thickness depending on the thickness of the skateboard deck. Example: if the deck is 1 inch in thickness than the metal plate will be a 0.25 of an inch, this is only to allow the screws that will pass through the pre-drilled and counter sunk metal plate to screw into the deck. The metal plate will lay into an area fit to its own size. This area will be routed to the thickness of the plate so the metal plate may lay flush to the bottom of the deck. The tips of the metal plates facing the ends of the skateboard deck will be protrude a 0.25 inch from the bottom of the deck to allow protection to the actual deck.

### EXAMPLE

the tips from the metal plates will act like a bumper to an automobile, therefore allowing the more valuable objects to endure the collision.

1. What I Lui Rasto Kodames claim as my invention is the skateboard with grooves in it for grip. And metal plates placed in routed areas under the front and rear end of the skateboard deck for protection from collision.
